(19) United States
(12) Patent Application Publication
(10) Pub. No.: US 2017/0080758 A1
(43) Pub. Date: Mar. 23, 2017

(54) CIVIL ENGINEERING VEHICLE TIRE WITH IMPROVED ENDURANCE

(71) Applicants: COMPAGNIE GENERALE DES ETABLISSEMENTS MICHELIN, Clemont-Ferrand (FR); MICHELIN RECHERCHE ET TECHNIQUE, S.A., Granges-Pacoot (CH)

(72) Inventors: Olivier SPINNLER, Ladoux, Clermont-Ferrand Cedex 9 (FR); Dominique CHAUVIN, Ladoux, Clermont-Ferrand Cedex 9 (FR)

(73) Assignees: COMPAGNIE GENERALE DES ETABLISSEMENTS MICHELIN, Clermont-Ferrand (FR); MICHELIN RECHERCHE ET TECHNIQUE, S.A., Granges-Paccot (CH)

(21) Appl. No.: 15/126,708

(22) PCT Filed: Mar. 17, 2015
(86) PCT No.: PCT/EP2015/055510

§ 371 Date: Sep. 16, 2016

(30) Foreign Application Priority Data
Mar. 18, 2014 (FR) 1452241

(51) Int. Cl. B60C 9/28; B60C 9/20; B60C 9/00; B60C 11/03

(52) U.S. Cl. CPC B60C 9/28; B60C 11/0306; B60C 9/2006; B60C 9/0007; B60C 2009/209; B60C 2011/0353; B60C 2011/0355; B60C 2200/065; B60C 2009/2016; B60C 2009/2019

(57) ABSTRACT

The tire has a crown part with sidewalls that end in beads. The crown part has a tread and a crown reinforcement. The crown reinforcement has protective, working and additional reinforcements. The protective reinforcement has a protective layer with elastic metal reinforcers which form an angle at least equal to 10°. The working reinforcement has working layers with crossed metal reinforcers and forming, with the circumferential direction, an angle at most equal to 60°. The additional reinforcement has a layer with an axial width at most equal to 0.9 times the shortest of the axial widths of the working layers and comprising metal reinforcers which form an angle at most equal to 25°. A tread pattern design of the tread has circumferentially oriented grooves. The mean axial distance between the two grooves closest to the equatorial midplane is greater than the maximum axial width of the additional reinforcement.

### CROSS-REFERENCE TO RELATED APPLICATION

The present invention claims priority to PCT International Patent Application Serial No. PCT/EP2015/055510 filed Mar. 17, 2015 entitled “Civil Engineering Vehicle Tire With Improved Endurance,” which claims the benefit of FR Patent Application Serial No. 1452241 filed Mar. 18, 2014, the entire disclosures of the applications being considered part of the disclosure of this application and hereby incorporated by reference.

### BACKGROUND OF THE INVENTION

1. Field of the Invention

The present disclosure relates to a radial tire intended to be fitted to a heavy vehicle of civil engineering type and more particularly to the crown part of such a tire, namely the part of the tire close to or in contact with the ground during running.

Although not restricted to this type of application, the disclosure is described with reference to a large-sized radial tire intended to be fitted to a vehicle of the dumper type, this being a vehicle that transports materials removed from quarries or open-cast mines. Typically, a radial tire for a heavy vehicle of civil engineering type, within the meaning of the European Tyre and Rim Technical Organisation (E.T.R.T.O.) standard, is intended to be mounted on a rim of at least 25 inch diameter.

Definitions:

Equatorial midplane: this is a plane perpendicular to the axis of rotation and passing through the points of the tire that are radially furthest from the said axis. This plane splits the tire into two equal halves.

A block is a raised element formed on the tread which is delimited by hollows or grooves and comprises lateral walls and a contact face intended to come into contact with the road surface. This contact face has a geometric center defined as being the barycenter or center of gravity of the face.

A rib is a raised element formed on a tread, this element extending in the circumferential direction and making a full circuit of the tire. A rib comprises two lateral walls and a contact face, the latter being intended to come into contact with the roadway during running.

A radial direction means in this document a direction perpendicular to the axis of rotation of the tire (this direction corresponds to the direction of the thickness of the tread).

A transverse or axial direction means a direction parallel to the axis of rotation of the tire. An oblique direction means a direction at a non-zero angle to the axial direction and making an angle smaller than 90 degrees with the circumferential direction.

A circumferential direction means a direction tangential to any circle centered on the axis of rotation. This direction is perpendicular both to the axial direction and to a radial direction.

Axially or radially towards the outside means a direction which is directed towards the outside of the internal tire cavity.

The usual running conditions for the tire or the service conditions are those defined in the E.T.R.T.O. standard; these service conditions specify the reference inflation pressure corresponding to the load bearing capability of the tire as indicated by its load index and speed rating. These service conditions may also be referred to as “nominal conditions” or “conditions of use”.

A cut generically means either a groove or a sipe and corresponds to the space delimited by walls of material that face one another and are distant from one another by a non-zero distance (referred to as the “width of the cut”). It is precisely this distance that differentiates a sipe from a groove: in the case of a sipe, this distance is suited to allowing the opposing walls delimiting the said sipe to come at least into partial contact at least as the sipe enters the contact patch in which it is in contact with the roadway. In the case of a groove, the walls of this groove cannot come into contact with one another under usual running conditions.

2. Related Art

A large-sized radial tire comprises a crown part, sidewalls extending the crown part on each side, the sidewalls ending in beads. These beads are intended to ensure the mechanical connection between the tire and the rim on which it is mounted.

The crown part of the tire comprises a reinforcing part surmounted radially on the outside by a tread intended to come into contact with the ground during running. This tread comprises radially on the outside a tread surface intended to provide contact between the tread and the ground.

A radial tire comprises a carcass reinforcement extending in the crown part of the tire, the sidewalls and anchoring into each bead. This carcass reinforcement is made up of one or more carcass layers, each carcass layer comprising a plurality of generally metal reinforcing cords arranged one next to the other in an elastomeric material, these reinforcing cords being oriented radially. The metal reinforcing cords of each carcass layer form, at any point, with the circumferential direction, an angle comprised between 85° and 95°.

Moreover, this carcass reinforcement is surmounted radially on the outside in the crown part by a crown reinforcement, the latter itself being surmounted by a tread.

This crown reinforcement is formed by the superposition of several crown layers, each crown layer being made up of reinforcing cords, generally metal, parallel to one another and coated in an elastomeric material (referred to as the “skim compound”). This crown reinforcement is arranged radially between the tread and the carcass reinforcement.

The crown reinforcement comprises a working reinforcement formed of at least two working layers having the function of belting the tire and providing the tire with stiffness and road holding. This crown reinforcement absorbs both the mechanical stresses of inflation, which are generated by the tire inflation pressure, and the mechanical stresses caused by running, which are generated as the tire runs over the ground and transmitted by its tread.

The working reinforcement usually comprises at least two working layers superposed radially one on the other, formed of inelastic metal reinforcers that are parallel to one another within each layer and crossed from one layer to the next forming, with the circumferential direction, angles at most equal to 60° and preferably at least equal to 15° and at most equal to 45°.

Moreover, a distinction is usually made between the protective layers that form a protective reinforcement intended to protect the working reinforcement from potential attack from sharp objects which could therefore weaken the tire. These protective layers are arranged as close as possible to the tread, namely radially on the outside of the working reinforcement.

The protective reinforcement generally comprises two radially superposed protective layers formed of metal cords said to be “elastic”, parallel to one another within each layer and crossing from one layer to the next, forming with the circumferential direction angles at least equal to 10° and at most equal to 35°, and preferably at least equal to 15° and at most equal to 33°.

Among the metal reinforcers a distinction is usually made between “elastic” metal reinforcers such as those used in the protective layers and inelastic metal reinforcers such as those used in the working layers.

An elastic metal reinforcer is characterized by a structural elongation As at least equal to 0.4% and a total elongation at break At at least equal to 3%. Furthermore, an elastic metal reinforcer has an elastic modulus in extension at most equal to 150 GPa and usually comprised between 40 GPa and 150 GPa.

An inelastic metal reinforcer is characterized by a relative elongation, under a tensile force equal to 10% of the breaking force Fm, at most equal to 0.2%. Moreover, an inelastic metal reinforcer has an elastic modulus in extension usually comprised between 150 GPa and 200 GPa.

In order to reduce the mechanical stresses of inflation which are transmitted to the working reinforcement, documents FR 2 419 181 and FR 2 419 182 disclose positioning radially between the working reinforcement and the carcass reinforcement an additional reinforcement also referred to as a “limiting block” the purpose of which is to at least partially absorb the mechanical stresses due to the inflation of the tire.

Document FR 2 419 181 describes and claims a crown reinforcement comprising a working reinforcement made up of at least two working layers of which the metal reinforcers form, with the circumferential direction, angles that are opposite from one layer to another and at least equal to 30°, and an additional reinforcement or limiting block, comprising at least two additional layers the metal reinforcers of which are not very extensible, i.e. are inelastic, and form, with the circumferential direction, angles that are opposite from one layer to the next and at most equal to one quarter of the smallest angle of the working layers.

Document FR 2 419 182 describes and claims a crown reinforcement comprising a working reinforcement made up of at least two working layers of which the metal reinforcers form, with the circumferential direction, angles that are opposite from one layer to the next and at least equal to 30°, and an additional reinforcement or limiting block comprising at least two layers the metal reinforcers of which are not very extensible, namely are inelastic, and form, with the circumferential direction, angles that are opposite from one layer to the next and at most equal to half the smallest angle of the working layers and preferably comprised between 5° and 10°.

Documents DE 3327670 A1 and U.S. Pat. No. 8,091,600 B2 disclose tire structures comprising a working reinforcement and an additional reinforcement, the latter being of a width that may be small.

Moreover, the tread of a tire intended to be fitted to a heavy vehicle of civil engineering type is provided with a tread pattern design formed by the presence of a plurality of grooves delimiting a plurality of raised elements (blocks and/or ribs). These grooves are intended to improve the performance of the tire in running over any kind of ground, notably muddy ground. As a general rule, the tread comprises at least two circumferentially oriented grooves and a plurality of transversely or obliquely oriented grooves.

It has been found that the combination of the internal reinforcing structure of the crown part and of the tread pattern design of the tread could have a significant effect on the impact resistance of the said crown part either at the level of the tread or at the level of the carcass reinforcement.

### BRIEF DESCRIPTION OF THE INVENTION

The applicant companies set themselves the objective of making the crown region of a radial tire for a heavy vehicle of civil engineering type less sensitive to the impacts that occur when running over ground containing numerous more or less aggressive bodies that generate repeated impacts and bendings that may cause fatigue cracking of the materials of which the tread is made.

This objective is achieved according to the disclosure using a tire for a heavy vehicle of civil engineering type, comprising:

a crown part extended on each side by sidewalls, these sidewalls ending in beads,

a carcass reinforcement extending into the crown part, the sidewalls and the beads,

this crown part comprising a tread having a wearing thickness and a crown reinforcement, the latter being situated radially between the tread and the carcass reinforcement,

the crown reinforcement comprising a protective reinforcement, a working reinforcement and an additional reinforcement,

the protective reinforcement comprising at least one protective layer comprising elastic metal reinforcers which form, with the circumferential direction, an angle at least equal to 10°,

the working reinforcement comprising at least two working layers having a respective axial width and comprising inelastic metal reinforcers crossed from one working layer to the next and forming, with the circumferential direction, an angle at most equal to 60°,

the additional reinforcement, centered axially on the equatorial midplane of the tire, comprising at least one layer having an axial width at most equal to 0.9 times the shortest of the axial widths of the at least two working layers and comprising metal reinforcers which form, with the circumferential direction, an angle at most equal to 25°, the tread being provided with a tread pattern design comprising at least one circumferentially oriented groove on each side of the equatorial midplane, the two circumferential grooves closest to the equatorial midplane delimiting a central region having a width equal to the mean distance between the said circumferential grooves, the central region being provided with a plurality of grooves of oblique or transverse orientation delimiting a plurality of blocks, this tread being such that:

the number of blocks in the central region over the entire periphery is at least equal to 42,

the mean axial distance between the two circumferential grooves closest to the equatorial midplane is greater than the maximum axial width of the additional reinforcement, this width being measured between the ends of the layers of this additional reinforcement that are axially furthest from the equatorial midplane, the axial ends of this additional reinforcement being offset axially towards the inside with respect to the said two circumferential grooves.

A groove of circumferential overall orientation may be rectilinear or alternatively may be zigzag or even undulate about a rectilinear mean position. The same may be true of the transversely or obliquely oriented grooves.

The maximum axial width of the additional reinforcement is equal to the width measured in the axial direction between the axial ends of this reinforcement that are most widely spaced on each side of the equatorial midplane.

“Offset axially towards the inside” is to be understood here as meaning that the ends of the additional reinforcement are situated between the grooves and the equatorial midplane.

According to one embodiment, the additional reinforcement is positioned between the carcass reinforcement and the working reinforcement, the latter reinforcement being surmounted by the protective reinforcement.

According to one preferred embodiment, the mean depth of the circumferential grooves is comprised between 65% and 80% of the wearing thickness of material.

By virtue of these measures it is possible to reduce the level of heat during running. Increasing the number of patterns per turn of the wheel has the effect of reducing the length of the raised elements in the circumferential direction. By increasing the depth of the grooves, the meridian flexural stiffness of the raised elements becomes less, resulting in an increase in the meridian flexing at the end of the limiting block.

The depth of the groove is limited to 80% of the wearing thickness of material so as to maintain enough of a mechanical connection between the shoulder part of the tread and the remainder of the tread in order to limit the risk of chunking if the material is heavily loaded with a great deal of side slip and/or loaded under a high degree of curvature.

According to one preferred embodiment, the mean axial distance between the two grooves closest to the equatorial midplane is at least equal to 1.1 times the axial width of the additional reinforcement and more preferably still at least 1.5 times the axial width of the additional reinforcement and at most 2.1 times.

According to one preferred embodiment, a circumferential groove is positioned on the midplane.

According to one preferred embodiment, the additional reinforcement comprises at least two layers.

According to a first alternative form relating to the reinforcers of each layer of the additional reinforcement, the metal reinforcers of the at least one layer are inelastic.

According to a second alternative form relating to the reinforcers of each layer of the additional reinforcement, the metal reinforcers of the at least one layer are elastic.

The elastic metal reinforcers of each protective layer preferably form, with the circumferential direction, an angle at least equal to 15° and at most equal to 40°.

For preference, the inelastic metal reinforcers of each working layer form, with the circumferential direction, an angle at least equal to 15° and at most equal to 45°.

Other features and advantages of the disclosure will emerge from the following description given with reference to the attached drawings which, by way of nonlimiting examples, show some embodiments of the subject matter of the disclosure.

### BRIEF DESCRIPTION OF THE FIGURES

FIG. 1 shows a surface view of one alternative form of tire according to the disclosure;

FIG. 2 shows a cross section through the tire depicted in FIG. 1.

This tire 1 is of size 50/80 R 57. It comprises a crown part comprising radially on the outside a tread 2 a surface of which constitutes a tread surface 20 intended to come into contact with the ground during running. This crown part is extended on each side by sidewalls 3, these sidewalls each ending in a bead (not depicted here) intended to come into contact with a mounting rim.

As may be seen in FIG. 2, this tire structure is reinforced, working from the crown part towards each bead, by a carcass reinforcement 4 formed in this instance of a reinforcing layer made up of a plurality of metal cords anchored at their ends to circumferential reinforcements arranged in each bead.

The crown part of this tire comprises a reinforcing structure comprising a working reinforcement 5 surmounted by a protective reinforcement 6 and by an additional reinforcement 7 between the working reinforcement 5 and the carcass reinforcement 4.

The working reinforcement 5 is formed of two working layers:

a first working layer 51 of width equal to 802 mm, this first working layer being made up of cords consisting of the assembly of 77 threads each 0.35 mm in diameter, each cord having a tensile breaking strength equal to 1900 daN; the cords of this layer make an angle close to 33 degrees with the circumferential direction;

a second working layer 52 formed with the same cords as the first working layer, these cords being laid at a mean angle equal to 19 degrees, these cords crossing the cords of the first working layer; the axial width of this layer is equal to 711 mm;

The working reinforcement 5 is surmounted radially on the outside by a protective reinforcement 6 made up of two layers referred to as protective layers, each protective layer being made up of a plurality of elastic cords formed, in the case of the layer 61 radially in contact with the second working layer 52, by the assembly of 24 threads measuring 0.26 mm in diameter and, in the case of the second protective layer 62, of cords referred to as elastic cords formed by the assembly of 52 threads measuring 0.26 mm in diameter; the cords of each protective layer are laid to make a mean angle equal to 24 degrees. The innermost protective layer 61 has a width equal to 939 mm whereas the outermost protective layer 62 has a width equal to 666 mm.

Finally, the working reinforcement 5 radially surmounts a limiting block 7 forming an additional reinforcement and consisting of a stack in the radial direction of two additional layers the metal reinforcers of which are not very extensible, namely are inelastic, and form, with the circumferential direction (perpendicular to the plane of the figure) angles that are opposite from one layer to the other and at most equal to half the smallest angle of the working layers and, in this instance, equal to 8 degrees. This limiting block 7 comprises a first layer 71 of axial width equal to 451 mm and radially on the outside of this first layer a second layer 72 of axial width equal to 380 mm. The cords that make up these layers 71, 72 are identical to those of the working layers 51, 52. This limiting block 7 is centered on the equatorial midplane (line XX′ in the plane of the figure) of the tire as are the other working and protective layers.

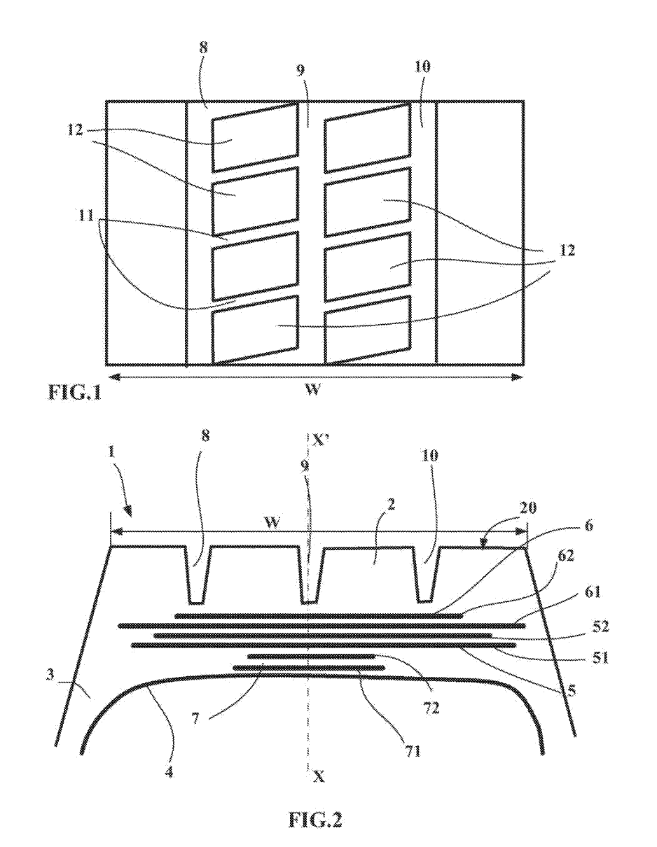

The tread of this tire has a width W and is provided with a tread pattern design as can be seen in FIG. 1 which shows a view of the tread surface of this tread. The tread pattern comprises three main grooves 8, 9, 10 of circumferential overall orientation making a complete circuit of the tire. The main groove 9 in the equatorial midplane XX′ has a width on the tread surface when new equal to 10 mm and a mean depth equal to 89 mm. The other two main grooves 8 and 10 on each side of the equatorial midplane have mean widths equal to 12 mm and mean depths equal to 70 mm.

Each main groove 8, 10 closest to the equatorial midplane XX′ is situated at a distance equal to 275 mm away from this equatorial midplane (this distance being measured between the midplane and a plane that divides each main groove into two equal parts). The two grooves 8 and 10 closest to the equatorial midplane delimit a central region in which there are formed several cuts oriented obliquely with respect to the transverse direction, these obliquely oriented grooves delimiting with the circumferential grooves a plurality of blocks of material in this central region. Over the entirety of the periphery of the tire the number of these blocks is, in this instance, equal to 42 (there are therefore two rows of 42 blocks because of the presence of a circumferential groove in the equatorial midplane). Another advantageous value for the number of blocks is 49 or even more.

The mean axial distance between the two axially outermost grooves is in this instance equal to 550 mm (this distance is measured between planes dividing each groove into two equal halves).

Thanks to this arrangement that combines both a high number of oblique grooves in the central region and the position of the ends of the layers of the limiting block 7 with respect to the circumferential main grooves, it is possible to improve the impact resistance and resistance to repeated bending of the crown part when running over ground covered with aggressive bodies, without thereby losing efficiency.

In the case of a very wide tread (which means to say one with a tread value greater than 900 mm, for example equal to at least 1040 mm), it is judicious to plan for the presence of four main grooves of circumferential overall orientation, two main grooves being located one on each side of the equatorial midplane. In this case, the position of the ends of the layers forming the limiting block is then determined so that these ends are situated between the main grooves closest to the equatorial midplane and on each side of this plane.

The disclosure described in connection with an example must not be restricted to this example alone and various modifications may be made thereto without departing from the scope as defined by the claims.

What is claimed is:

1. A tire for a heavy vehicle of civil engineering type, comprising:
a crown part extended on each side by sidewalls, the sidewalls ending in beads,
a carcass reinforcement extending into the crown part, the sidewalls and the beads, the crown part comprising a tread having a wearing thickness and a crown reinforcement, the crown reinforcement being situated radially between the tread and the carcass reinforcement,
the crown reinforcement comprising a protective reinforcement, a working reinforcement and an additional reinforcement,
the protective reinforcement comprising at least one protective layer comprising elastic metal reinforcers which form, with the circumferential direction, an angle at least equal to 10°,
the working reinforcement comprising at least two working layers having a respective axial width and comprising inelastic metal reinforcers crossed from one working layer to the next and forming, with the circumferential direction, an angle at most equal to 60°,
the additional reinforcement, centered axially on the equatorial midplane of the tire, comprising at least one layer having an axial width at most equal to 0.9 times the shortest of the axial widths of the at least two working layers and comprising metal reinforcers which form, with the circumferential direction, an angle at most equal to 25°,
the tread being provided with a tread pattern design comprising at least one circumferentially oriented groove on each side of the equatorial midplane, the two circumferential grooves closest to the equatorial midplane delimiting a central region having a width equal to the mean distance between the said circumferential grooves,
the central region being provided with a plurality of grooves of oblique or transverse orientation so as to form a plurality of blocks,
wherein the number of blocks in the central region over the entire periphery is at least equal to 42, and wherein
the mean axial distance between the two circumferential grooves closest to the equatorial midplane is greater than the maximum axial width of the additional reinforcement, the maximum axial width being measured between the ends of the layers of this additional reinforcement that are axially furthest from the equatorial midplane, the axial ends of this additional reinforcement being offset axially towards the inside with respect to the said two circumferential grooves.

2. The tire for a heavy vehicle of civil engineering type as set forth in claim 1, wherein the mean depth of the circumferential grooves is comprised between 65% and 80% of the wearing thickness of material.

3. The tire for a heavy vehicle of civil engineering tire as set forth in claim 1, wherein the mean axial distance between the two grooves closest to the equatorial midplane is at least equal to 1.1 times the axial width of the additional reinforcement.

4. The tire for a heavy vehicle of civil engineering tire as set forth in claim 3, wherein the mean axial distance between the two grooves closest to the equatorial midplane is at least 1.5 times the axial width of the additional reinforcement and at most 2.1 times.

5. The tire for a heavy vehicle of civil engineering type as set forth in claim 1, wherein a circumferential groove is also positioned on the midplane in order to split the central region into two halves.

6. The tire for a heavy vehicle of civil engineering type as set forth in claim 1, wherein the additional reinforcement comprises at least two layers.

7. The tire for a heavy vehicle of civil engineering type as set forth in claim 6, wherein the metal reinforcers of at least one layer of the additional reinforcement are inelastic.

8. The tire for a heavy vehicle of civil engineering type as set forth in claim 7, wherein the metal reinforcers of at least one layer of the additional reinforcement are elastic.

9. The tire for a heavy vehicle of civil engineering type as set forth in claim 1, wherein the elastic metal reinforcers of each protective layer preferably form, with the circumferential direction, an angle at least equal to 15° and at most equal to 40°.
